(19) United States
(12) Patent Application Publication
(10) Pub. No.: US 2014/0176886 A1
(43) Pub. Date: Jun. 26, 2014

(54) DISPLAY DEVICE

(71) Applicant: Masahiro Yoshida, Osaka-shi (JP)

(72) Inventor: Masahiro Yoshida, Osaka-shi (JP)

(73) Assignee: Sharp Kabushiki Kaisha, Osaka-shi, Osaka (JP)

(21) Appl. No.: 14/237,668

(22) PCT Filed: Jul. 31, 2012
(86) PCT No.: PCT/JP2012/069484

§ 371 Date: Feb. 7, 2014

(30) Foreign Application Priority Data
Aug. 9, 2011 (JP) 2011-173493

(51) Int. Cl. G02F 1/1343; G02F 1/1339

(52) U.S. Cl. CPC G02F 1/134309; G02F 1/1339
USPC 349/110; 349/139; 349/138

(57) ABSTRACT

An objective is to provide a display device where the width of the surrounding region may be reduced even with an increased number of lead lines. The display device includes: a rectangular array substrate (16); a counter substrate (18) spaced apart from the array substrate; display material (20) disposed between the array substrate and the counter substrate; a seal member (22) sealing in the display material between the array substrate and the counter substrate; and a group of lead lines including lead lines (44a to 44c) connected with signal lines formed on the array substrate, wherein the seal member includes a parallel portion (22a) extending generally in the same direction as one side of the array substrate, each of the lead lines includes an extended portion (46a to 46c) extending parallel to the parallel portion, the lead lines are provided separately in at least three line layers deposited on the array substrate, and the extended portion overlaps the parallel portion as viewed in a direction normal to the array substrate.

### TECHNICAL FIELD

The present invention relates to display devices.

### BACKGROUND ART

Display devices such as liquid crystal display devices are known. A recent trend is an increasing number of signal lines to realize high-resolution image display. This entails an increase in the number of lead lines connected with the signal lines. The lead lines may be provided in the surrounding region (also called picture-frame region) of the display region.

### DISCLOSURE OF THE INVENTION

JP 2010-175700 A discloses a liquid crystal display device including scanning routed lines in three layers. In this liquid crystal display device, all the scanning routed lines are located inwardly of the seal material. Scanning routed lines in each layer must be spaced apart from each other to prevent a leakage. That is, if all the scanning routed lines are to be provided inwardly of the seal member, the area between the seal member and display region must be relatively large. As a result, it is difficult to reduce the width of the surrounding region.

An object of the present invention is to provide a display device where the width of the surrounding region may be reduced even with an increased number of lead lines.

A display device according to the present invention includes: a rectangular array substrate; a counter substrate spaced apart from the array substrate; display material disposed between the array substrate and the counter substrate; a seal member sealing in the display material between the array substrate and the counter substrate; and a group of lead lines including lead lines connected with signal lines formed on the array substrate, wherein the seal member includes a parallel portion extending parallel to one side of the array substrate, each of the lead lines includes an extended portion extending generally in the same direction as the parallel portion, the lead lines included in the group of lead lines are provided separately in at least three line layers deposited on the array substrate, and the extended portion overlaps the parallel portion as viewed in a direction normal to the array substrate.

In the display device of the present invention, the width of the surrounding region may be reduced even with an increased number of lead lines.

### BRIEF DESCRIPTION OF THE DRAWINGS

FIG. 1 is a schematic plan view of an exemplary display device of an embodiment of the present invention.

FIG. 2 is an enlarged plan view of a portion of the display device of FIG. 1.

FIG. 3 is an enlarged cross-sectional view of an exemplary arrangement of gate lead lines, taken on line III-III of FIG. 2.

FIG. 4 is a circuit diagram of an exemplary switching device.

FIG. 5 is an enlarged cross-sectional view of an exemplary arrangement of portions of gate lead lines present in the first region that cross the seal member.

FIG. 6 is an enlarged cross-sectional view of an example of the terminal of a first gate lead line.

FIG. 7 is an enlarged cross-sectional view of an example of the terminal of a second gate lead line.

FIG. 8 is an enlarged cross-sectional view of an example of the terminal of a third gate lead line.

FIG. 9 is an enlarged cross-sectional view of an exemplary arrangement of portions of source lead lines that cross the seal member.

FIG. 10 is an enlarged cross-sectional view of an exemplary structure that allows the array substrate to electrically communicate with the counter substrate.

FIG. 11 is an enlarged cross-sectional view of an exemplary arrangement of source lead lines of a display device of Application 1 of the embodiment of the present invention.

FIG. 12 is an enlarged cross-sectional view of an exemplary arrangement of source lead lines of a display device of Application 2 of the embodiment of the present invention.

FIG. 13 is an enlarged cross-sectional view of an exemplary arrangement of source lead lines of a display device of Application 3 of the embodiment of the present invention.

FIG. 14 is an enlarged cross-sectional view of an exemplary arrangement of source lead lines of a display device of Application 4 of the embodiment of the present invention.

FIG. 15 is an enlarged cross-sectional view of an exemplary arrangement of source lead lines of a display device of Application 5 of the embodiment of the present invention.

FIG. 16 is an enlarged cross-sectional view of an exemplary arrangement of source lead lines of a display device of Application 6 of the embodiment of the present invention.

FIG. 17 is an enlarged cross-sectional view of an example of the terminal of a gate lead line of a display device of Application 7 of the embodiment of the present invention.

FIG. 18 is an enlarged cross-sectional view of an exemplary arrangement of gate lead lines of a display device of Application 8 of the embodiment of the present invention.

FIG. 19 is an enlarged cross-sectional view of an exemplary arrangement of gate lead lines of a display device of Application 9 of the embodiment of the present invention.

FIG. 20 is an enlarged cross-sectional view of an exemplary arrangement of gate lead lines of a display device of Application 10 of the embodiment of the present invention.

FIG. 21 is an enlarged cross-sectional view of an exemplary arrangement of gate lead lines of a display device of Application 11 of the embodiment of the present invention.

FIG. 22 is a schematic plan view of an exemplary display device of Application 12 of the embodiment of the present invention.

FIG. 23 is a schematic plan view of an exemplary display device of Application 13 of the embodiment of the present invention.

FIG. 24 is a schematic plan view of an exemplary display device of Application 14 of the embodiment of the present invention.

### EMBODIMENTS FOR CARRYING OUT THE INVENTION

The display device according to an embodiment of the present invention includes: a rectangular array substrate; a counter substrate spaced apart from the array substrate; display material disposed between the array substrate and the counter substrate; a seal member sealing in the display material between the array substrate and the counter substrate; and a group of lead lines including lead lines connected with signal lines formed on the array substrate, wherein the seal member includes a parallel portion extending parallel to one side of the array substrate, each of the lead lines includes an extended portion extending generally in the same direction as the parallel portion, the lead lines included in the group of lead lines are provided separately in at least three line layers deposited on the array substrate, and the extended portion overlaps the parallel portion as viewed in a direction normal to the array substrate (first arrangement).

In the first arrangement, the lead lines may be arranged such that some lead lines overlap other ones as viewed in a direction normal to the array substrate, for example. Further, the area where the lead lines are located overlaps the seal member (or its parallel portion) as viewed in a direction normal to the array substrate. Thus, the lead lines may be arranged in more various ways. As a result, the width of the surrounding region is less likely to increase even with an increased number of lead lines.

In a second arrangement, starting from the first arrangement, extended portions in at least two of the line layers overlap the parallel portion as viewed in a direction normal to the array substrate. In this arrangement, the lead lines may be arranged in yet more various ways.

In a third arrangement, starting from the second arrangement, the at least two of the line layers include: a first line layer located closest to a base substrate of the array substrate; and a second line layer located adjacent the side of the first line layer opposite that facing the base substrate and located closest to the first line layer, and an insulating layer provided between the second line layer and the parallel portion has a thickness larger than that of an insulating film provided between the first line layer and the second line layer. In this arrangement, the lead lines may be positioned distant from the parallel portion. This will prevent a lead line from being broken when the array substrate is attached to the counter substrate.

In a fourth arrangement, starting from the third arrangement, the parallel portion includes a spacer that defines the distance between the array substrate and the counter substrate. In this arrangement, a lead line may be prevented from being broken even when the parallel portion includes a spacer.

In a fifth arrangement, starting from the third or fourth arrangement, the parallel portion contains conductive particles. In this arrangement, a lead line may be prevented from electrically communicating with another via conductive particles when the array substrate is attached to the counter substrate.

In a sixth arrangement, starting from one of the third to fifth arrangements, the insulating layer includes an organic insulating film. In this arrangement, a certain thickness of the insulating layer may be easily ensured.

In a seventh arrangement, starting from the second arrangement, the at least two of the line layers include: a first line layer located closest to a base substrate of the array substrate; and a third line layer located closest to the seal member. In this arrangement, a lead line is located distant from another as measured in a thickness direction of the array substrate. This will reduce parasitic capacitance produced between lead lines. This in turn will minimize delay in signal transfer.

In an eighth arrangement, starting from one of the second to seventh arrangements, the counter substrate includes a light-shielding layer overlapping the parallel portion as viewed in a direction normal to the counter substrate, a gap is formed between two of the extended portions overlapping the parallel portion as viewed in a direction normal to the array substrate, the two extended portions being adjacent to each other as measured in a width direction of the parallel portion, and the seal member is a photocurable resin. In this arrangement, incomplete curing of the seal member may be prevented even though the seal member is a photocurable resin.

In a ninth arrangement, starting from one of the first to seventh arrangements, the seal member is a thermosetting resin. In this arrangement, incomplete curing of the seal member may be prevented if, for example, the counter substrate includes a light shielding portion located to overlap the parallel portion as viewed in a direction normal to the counter substrate and there is no gap between two of the extended portions overlapping the parallel portion as viewed in a direction normal to the array substrate, the two extended portions being adjacent in a width direction of the parallel portion.

In a tenth arrangement, starting from one of the first to ninth arrangements, the extended portion is located inward of the seal member as viewed in a direction normal to the array substrate. In this arrangement, the lead lines may be arranged in a yet more various ways.

In an eleventh arrangement, starting from one of the first to tenth arrangements, the extended portion is located outward of the seal member as viewed in a direction normal to the array substrate. In this arrangement, the lead lines may be arranged in a still more various ways.

In a twelfth arrangement, starting from the eleventh arrangement, the extended portion located outward of the seal member as viewed in a direction normal to the array substrate is provided in a line layer located closer to a base substrate of the array substrate than the one of the at least three line layers deposited on the array substrate which is located closest to the seal member. In this arrangement, lead lines with their extended portions located outward of the seal member as viewed in a direction normal to the array substrate are located distant from the seal member as measured in a thickness direction of the array substrate. As a result, such lead lines may be prevented from corroding.

In a thirteenth arrangement, starting from one of the first to twelfth arrangements, each of the lead lines included in the group of lead lines has a terminal connected with a drive circuit mounted on the array substrate, and the terminals have the same structure. In this arrangement, the connection between the drive circuit and the terminals is stable.

In a fourteenth arrangement, starting from the thirteenth arrangement, each terminal includes a plurality of conductive layers deposited on each other. In this arrangement, the connection between the drive circuit and the terminals is yet more stable. Further, the footprint of the terminals may be reduced.

Now, a more specific embodiment of the present invention will be described with reference to the drawings. For ease of explanation, the drawings to which reference will be made below schematically show only those of the components of the embodiment of the present application that are necessary to describe the present invention. As such, the display device according to the present invention may include any component that is not shown in the drawings which the present specification refers to. The same or corresponding parts in the drawings are labeled with the same characters, and their description will not be repeated.

### Embodiment

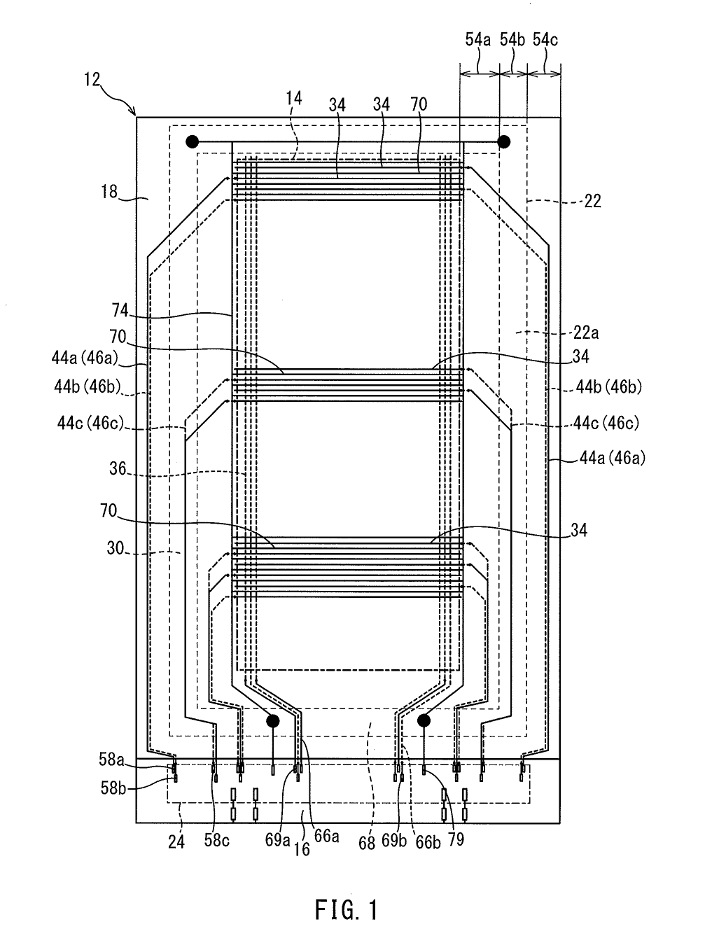

A liquid crystal panel 12 included in a display device of an embodiment of the present invention will be described with reference to FIGS. 1 to 10. The display device may be a display used in, for example, a mobile phone, a portable digital assistance, a game machine, a digital camera, a printer, a car navigation system, and an intelligent home appliance.

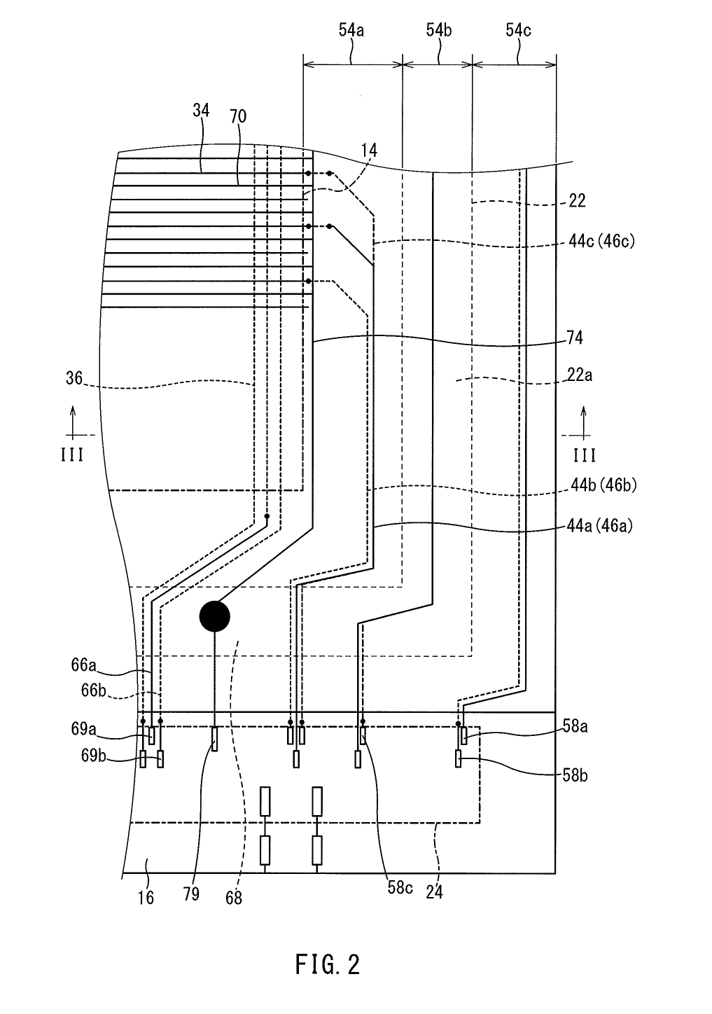

The liquid crystal panel 12 includes a plurality of pixels. The pixels may be arranged in a matrix, for example. The region with the pixels constitutes a display region 14 (see FIGS. 1 and 2) of the liquid crystal panel 12.

Each pixel may include a plurality of subpixels. Subpixels may include, for example, a red pixel, a green pixel and a blue pixel. Subpixels may further include a yellow pixel.

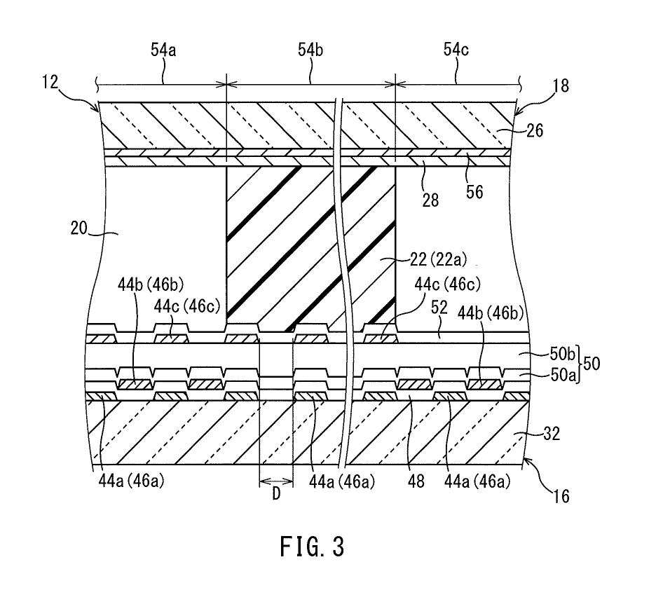

As shown in FIG. 3, the liquid crystal panel 12 includes an array substrate 16, a counter substrate 18, liquid crystal 20 that serves as display material, and a seal member 22.

As shown in FIGS. 1 and 2, the array substrate 16 is rectangle in shape. The array substrate 16 includes a drive circuit 24. In response to a signal from the drive circuit 24, the liquid crystal panel 12 displays an image. The drive circuit 24 is connected with an external device via a flexible printed circuit (FPC), not shown. The array substrate 16 will be described in detail further below.

As shown in FIG. 3, the counter substrate 18 is disposed opposite the array substrate 16. The counter substrate 18 includes a base substrate 26. The base substrate 26 may be a non-alkali glass, for example.

The counter substrate 18 includes a common electrode 28. The common electrode 28 may be an indium tin oxide film, for example. The common electrode 28 may be provided across the entire display region 14 of the liquid crystal panel 12, for example. Although not shown in FIG. 3, the common electrode 28 is covered with an alignment film.

The liquid crystal 20 is disposed between the array substrate 16 and counter substrate 18. The liquid crystal 20 may be driven using any technique (operational mode).

The seal member 22 seals in the liquid crystal 20 between the array substrate 16 and counter substrate 18. The seal member 22 may be, for example, a photocurable resin or thermosetting resin. The seal member 22 is in the shape of a rectangular frame, as shown in FIG. 1. The seal member 22 has at least one parallel portion 22a extending parallel to one side of the array substrate 16 (a side extending vertically in FIG. 1). The parallel portion 22a need not be exactly parallel to a side of the array substrate 16.

As shown in FIG. 3, the array substrate 16 includes a base substrate 32. The base substrate 32 may be, for example, a non-alkali glass substrate.

As shown in FIGS. 1 and 2, the array substrate 16 includes a plurality of gate lines 34 and a plurality of source lines 36. The gate lines 34 extend horizontally with respect to the base substrate 32 (i.e. in a left-to-right direction in FIG. 1). The source lines 36 extend vertically with respect to the base substrate 32 (i.e. in a top-to-bottom direction in FIG. 1). The gate lines 34 and source lines 36 may be made of, for example, a metal film of aluminum, copper, titanium, molybdenum and chromium, or a lamination thereof.

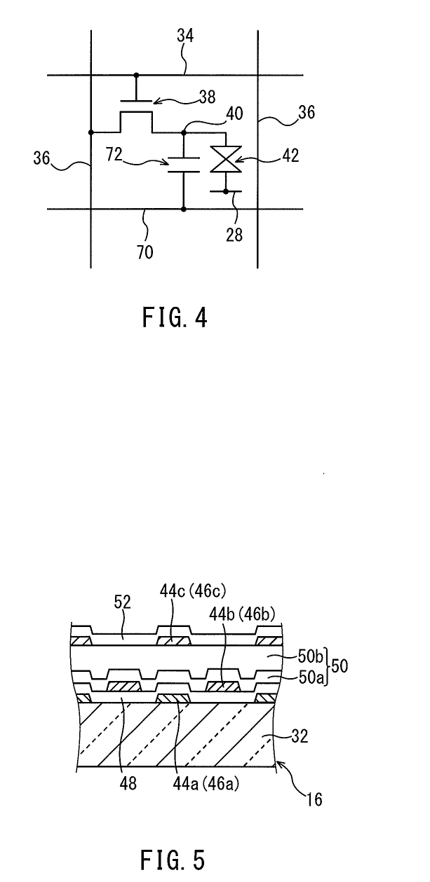

As shown in FIGS. 1, 2 and 4, the gate lines 34 intersect source lines 36. As shown in FIG. 4, a thin-film transistor 38 that serves as a switching device is disposed near the intersection of a gate line 34 and source line 36.

The gate electrode of the thin-film transistor 38 is connected with the gate line 34. The source electrode of the thin-film transistor 38 is connected with the source line 36. The drain electrode of the thin-film transistor 38 is connected with a pixel electrode 40. The pixel electrode 40 may be, for example, a transparent electrode made of an indium tin oxide film, or may be a reflective electrode made of aluminum, platinum or nickel.

The pixel electrode 40 faces the common electrode 28. The liquid crystal 20 is disposed between the pixel electrode 40 and common electrode 28. The pixel electrode 40, common electrode 28 and liquid crystal 20 constitute a liquid crystal capacitor 42.

As shown in FIGS. 1 and 2, gate lead lines 44a to 44c are connected with the gate lines 34. The gate lead lines 44a to 44c may be made of, for example, a metal film of aluminum, copper, titanium, molybdenum and chromium, or a lamination thereof.

As shown in FIG. 3, the gate lead lines 44a to 44c are distributed among a plurality of line layers deposited on the base substrate 32. The gate lead lines 44a to 44c have the same width.

As shown in FIGS. 1 to 3, the gate lead lines 44a to 44c each include an extended portion, 46a to 46c, extending parallel to the parallel portion 22a. The extended portions 46a to 46c need not be exactly parallel to the parallel portion 22a.

As shown in FIG. 3, the first gate lead lines 44a are located on the base substrate 32. Although not shown, the gate lines 34 are located on the base substrate 32. In other words, the first gate lead lines 44a and gate lines 34 are provided in the same line layer (the first line layer).

As shown in FIG. 3, the second gate lead lines 44b are located on a gate insulating film 48. The gate insulating film 48 covers the gate lines 34 (not shown in FIG. 3) and the first gate lead lines 44a. The gate insulating film 48 may be, for example, a silicon nitride film or silicon oxide film.

Although not shown, the source lines 36 are located on the gate insulating film 48. In other words, the second gate lead lines 44b and source lines 36 are provided in the same line layer (the second line layer). The second gate lead lines 44b may be connected with the gate lines 34 via contact holes (not shown) formed in the gate insulating film 48, for example.

As shown in FIG. 3, the third gate lead lines 44c are located on a first passivation film 50. The first passivation film 50 covers the source lines 36 (not shown in FIG. 3) and the second gate lead lines 44b. The third gate lead lines 44c may be connected with the gate lines 34 via contact holes (not shown) formed in the first passivation film 50 and gate insulating film 48, for example.

The first passivation film 50 may be, for example, a silicon nitride film, a silicon oxide film, an acrylic resin-based photosensitive resin film, or a lamination thereof. The first passivation film 50 has a thickness larger than that of the gate insulating film 48.

As shown in FIG. 3, in the present embodiment, the first passivation film 50 is a lamination. More specifically, the first passivation film 50 includes an inorganic insulating film 50a covering the source lines 36 (not shown in FIG. 3) and second gate lead lines 44b, and an organic insulating film 50b covering the inorganic insulating film 50a.

The inorganic insulating film 50a may be, for example, a silicon nitride film or a silicon oxide film. The organic insulating film 50b may be, for example, an acrylic photosensitive resin film. The organic insulating film 50b has a thickness larger than that of the inorganic insulating film 50a.

For example, the inorganic insulating film 50a may be formed by CVD or sputtering to have a thickness of about 0.2 μm to 0.7 μm, while the organic insulating film 50b may be formed by spin coating to have a thickness of about 1 μm to 4 μm.

The third gate lead lines 44c are provided in the one of the line layers that is located closest to the seal member 22 (i.e. the third line layer). The third gate lead lines 44c are covered with a second passivation film 52. The second passivation film 52 may be, for example, a silicon nitride film, a silicon oxide film, an acrylic resin-based photosensitive resin film, or a lamination thereof. The second passivation film 52 has a thickness smaller than that of the first passivation film 50.

Although not shown in FIG. 3, the pixel electrodes 40 are formed on the second passivation film 52. Although not shown in FIG. 3, the pixel electrodes 40 and second passivation film 52 are covered with the alignment film.

As shown in FIGS. 1 and 3, the gate lead lines 44a to 44c are located in first to third regions 54a to 54c as viewed from the front side of the liquid crystal panel 12 (i.e. as viewed in a direction normal to the array substrate 16 and counter substrate 18). As viewed from the front side of the liquid crystal panel 12, the first region 54a is located outward of the display region 14 and inward of the seal member 22. As viewed from the front side of the liquid crystal panel 12, the second region 54b overlaps the parallel portion 22a of the seal member 22. As viewed from the front side of the liquid crystal panel 12, the third region 54c is located outward of the seal member 22.

As shown in FIGS. 1 to 3, first to third gate lead lines 44a to 44c are provided in the first region 54a. In the first region 54a, the first gate lead lines 44a (particularly, the extended portions 46a) may be at the same distance or different distances. The same applies to the second gate lead lines 44b and third gate lead lines 44c.

A portion of a first gate lead line 44a that is located between its extended portion 46a and the associated gate line 34 need not form an angle of about 45 degrees with the extended portion 46a, as shown in FIGS. 1 and 2. The portions between the extended portions 46a and gate lines 34 may be parallel or not parallel to each other. The same applies to the second gate lead lines 44b and third gate lead lines 44c.

As shown in FIG. 3, as viewed from the front side of the liquid crystal panel 12, in the first region 54a, the extended portion 46a of a first gate lead line 44a overlaps the extended portion 46c of a third gate lead line 44c. As viewed from the front side of the liquid crystal panel 12, in the first region 54a, no gap is formed between the extended portion 46a of a first gate lead line 44a and the extended portion 46b of a second gate lead line 44b, and between the extended portion 46b of a second gate lead line 44b and the extended portion 46c of a third gate lead line 44c. This does not mean that no gap at all is formed between such extended portions, but a small gap may be formed.

In the intersections of the gate lead lines 44a to 44c in the first region 54a and the seal member 22 (i.e. a section 68 of the seal member 22, described further below), the gate lead lines are desirably dispersed in a horizontal direction with respect to the liquid crystal panel 12 (i.e. a horizontal direction in FIG. 1), as shown FIG. 5, for example. In the implementation shown in FIG. 5, as viewed from the front side of the liquid crystal panel 12, a first gate lead line 44a overlaps a third gate lead line 44c. As viewed from the front side of the liquid crystal panel 12, a gap is formed between a first gate lead line 44a (or a third gate lead line 44c) and a second gate lead line 44b.

As shown in FIGS. 1 to 3, first and third gate lead lines 44a and 44c are provided in the second region 54b. In the second region 54b, the first gate lead lines 44a (particularly the extended portions 46a) may be at the same distance or different distances. The same applies to the third gate lead lines 44c.

As shown in FIG. 3, as viewed from the front side of the liquid crystal panel 12, in the second region 54b, the extended portion 46a of a first gate lead line 44a overlaps the extended portion 46c of a third gate lead line 44c. More specifically, in the present embodiment, as viewed from the front side of the liquid crystal panel 12, the extended portion 46a of a first gate lead line 44a overlaps the extended portion 46c of a third gate lead line 44c without a displacement in a width direction of the parallel portion 22a.

As viewed from the front side of the liquid crystal panel 12, in the second region 54b, a gap D is formed between two adjacent extended portions arranged in a width direction of the parallel portion 22a. The gap D has a width of 2.5 to 20 μm.

In the second region 54b, a light-shielding layer is provided on the counter substrate 18. The light-shielding layer may be, for example, a black matrix for color filters on the counter substrate 18. In the present embodiment, as shown in FIG. 3, the light-shielding layer 56 is present not only in the second region 54b, but also in the first and third regions 54a and 54c.

As shown in FIGS. 1 to 3, first and second gate lead lines 44a and 44b are provided in the third region 54c. In the third region 54c, the first gate lead lines 44a (particularly, the extended portions 46a) may be at the same distance or different distances. The same applies to the second gate lead lines 44b.

As shown in FIG. 3, as viewed from the front side of the liquid crystal panel 12, in the third region 54c, no gap is formed between the extended portion 46a of a first gate lead line 44a and the extended portion 46b of a second gate lead line 44b. This does not mean that no gap at all is formed between such extended portions, but a small gap may be formed.

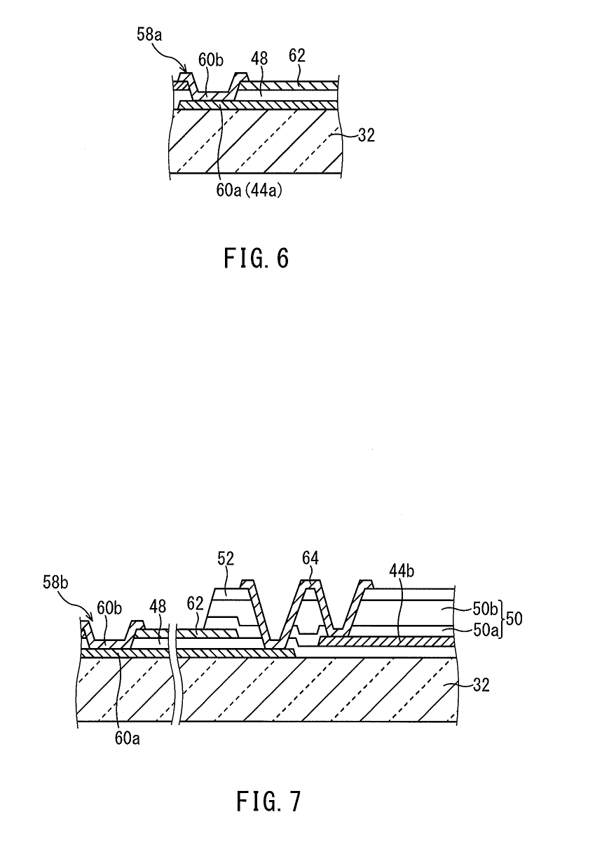

As shown in FIGS. 1 and 2, a terminal, designated by any one of 58a to 58c, is provided on each of the gate lead lines 44a to 44c. Each of the terminals 58a to 58c electrically connects the drive circuit 24 mounted on the array substrate 16 with the corresponding one of the gate lead lines 44a to 44c. These terminals 58a to 58c will be described with reference to FIGS. 6 to 8.

FIG. 6 shows a terminal 58a provided on a first gate lead line 44a. The terminal 58a includes a plurality of conductive films deposited on each other. In the present embodiment, the terminal 58a includes a first electrode film 60a and a second electrode film 60b deposited on each other. The first electrode film 60a is provided on the base substrate 32. In the terminal 58a, the first gate lead line 44a serves as the first electrode film 60a. The second electrode film 60b is provided in the same layer as the pixel electrodes 40.

In the present embodiment, as shown in FIGS. 6 to 8, a semiconductor film 62 is formed on the gate insulating film 48. The semiconductor film 62 serves as an etching barrier layer for protecting those portions of the gate insulating film 48 that must not be etched when the gate insulating film 48 and passivation films 50 and 52 are successively etched.

FIG. 7 shows a terminal 58b connected with a second gate lead line 44b. The terminal 58b includes a plurality of conductive films deposited on each other. In the present embodiment, the terminal 58b includes a first electrode film 60a and a second electrode film 60b deposited on each other. The first electrode film 60a is formed on the base substrate 32. In other words, the first electrode film 60a is provided in the same line layer as the gate lines 34 and first gate lead lines 44a. The first electrode film 60a is separate from the gate lines 34 and first gate lead lines 44a. The second electrode film 60b is provided in the same layer as the pixel electrodes 40.

As shown in FIG. 7, the first electrode film 60a is electrically connected with the second gate lead line 44b via a connection electrode film 64. The connection electrode film 64 is provided in the same layer as the pixel electrodes 40.

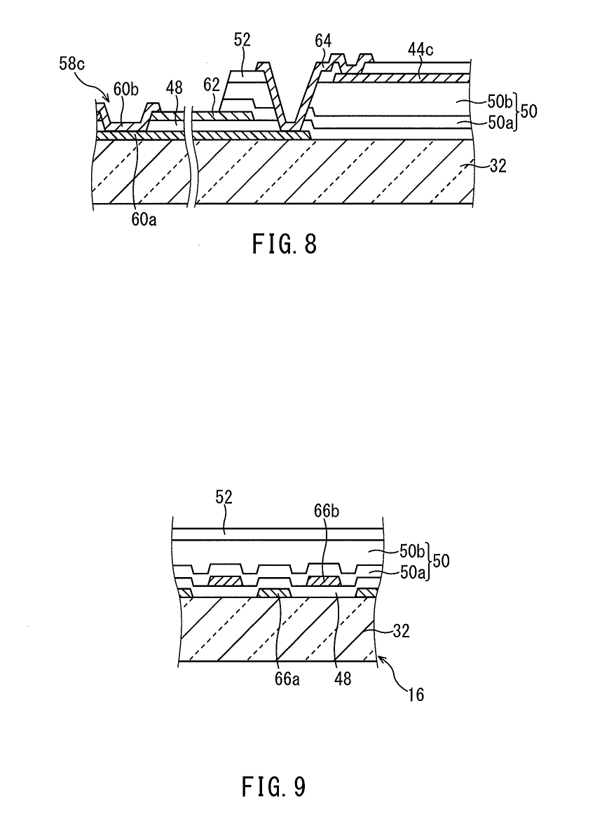

FIG. 8 shows a terminal 58c connected with a third gate lead line 44c. The terminal 58c includes a plurality of conductive films deposited on each other. In the present embodiment, the terminal 58c includes a first electrode film 60a and a second electrode film 60b deposited on each other. The first electrode film 60a is formed on the base substrate 32. In other words, the first electrode film 60a is provided in the same line layer as the gate lines 34 and first gate lead lines 44a. The first electrode film 60a is separate from the gate lines 34 and first gate lead lines 44a. The second electrode film 60b is provided in the same layer as the pixel electrodes 40.

As shown in FIG. 8, the first electrode film 60a is electrically connected with the third gate lead line 44c via a connection electrode film 64. The connection electrode film 64 is provided in the same layer as the pixel electrodes 40.

As shown in FIGS. 1 and 9, source lead lines 66a and 66b are connected with the source lines 36. The source lead lines 66a and 66b may be made of, for example, a metal film of aluminum, copper, titanium, molybdenum and chromium, or a lamination thereof.

As shown in FIG. 9, the source lead lines 66a and 66b are distributed among a plurality of line layers deposited on the base substrate 32. The first and second source lead lines 66a and 66b have the same width.

The first source lead lines 66a are provided in the same line layer as the gate lines 34 and first gate lead lines 44a. The second source lead lines 66b are provided in the same line layer as the source lines 36 and second gate lead lines 44b.

As shown in FIGS. 1 and 2, as viewed from the front side of the liquid crystal panel 12, the source lead lines 66a and 66b cross a section 68 of the seal member 22. The section 68 is located near the drive circuit 24 and parallel to a side of the array substrate 16 (a side extending horizontally in FIG. 1).

As viewed from the front side of the liquid crystal panel 12, the first and second source lead lines 66a and 66b overlap the section 68 of the seal member 22. In this section, the first source lead lines 66a may be at the same distance or different distances. The same applies to the second source lead lines 66b.

The first source lead lines 66a may be parallel or not parallel to each other. The same applies to the second source lead lines 66b.

As shown in FIG. 9, as viewed from the front side of the liquid crystal panel 12, a gap is formed between a portion of a first source lead line 66a that overlaps the section 68 of the seal member 22 and such a portion of a second source lead line 66b.

As shown in FIGS. 1 and 2, each of the source lead lines 66a and 66b has a terminal, designated by 69a or 69b. The terminals 69a and 69b of the source lead lines 66a and 66b have the same structure as the terminals 58a and 58b of the gate lead lines 44a and 44b.

The gate lead lines 44a to 44c and source lead lines 66a and 66b are connected with the drive circuit 24 mounted on the array substrate 16. The gate lines 34 and gate lead lines 44a to 44c convey scan signals from the drive circuit 24. The source lines 36 and source lead lines 66a and 66b convey display signals from the drive circuit 24. In response to a scan signal received by a gate electrode, the associated thin-film transistor 38 is driven. When the thin-film transistor 38 is on, a display signal is fed into the pixel electrode 40 via the thin-film transistor 38 to apply a voltage to the liquid crystal 20 between the pixel electrode 40 and the common electrode 28. A charge that is dependent on the display signal is accumulated in the liquid crystal capacitor 42. This controls the alignment of liquid crystal molecules to control the light transmission rate of the associated pixel. As a result, the liquid crystal panel 12 displays an image.

As shown in FIGS. 1 and 2, a storage capacitance line 70 is disposed between two adjacent gate lines 34. The storage capacitance line 70 may be made of, for example, a metal film of aluminum, copper, titanium, molybdenum and chromium, or a lamination thereof.

The storage capacitance line 70 faces an electrode connected with the drain electrode of the thin-film transistor 38 (i.e. a storage capacitance counter electrode). The pixel electrode 40 may serve as a storage capacitance counter electrode. For example, an insulator such as the gate insulating film 48 or passivation film 50 is located between the storage capacitance line 70 and storage capacitance counter electrode. The storage capacitance line 70, storage capacitance counter electrode and insulator form a storage capacitor 72.

As shown in FIGS. 1 and 2, storage capacitance lines 70 are connected with a common electrode line 74. The common electrode line 74 may be made of, for example, a metal film of aluminum, copper, titanium, molybdenum and chromium, or a lamination thereof.

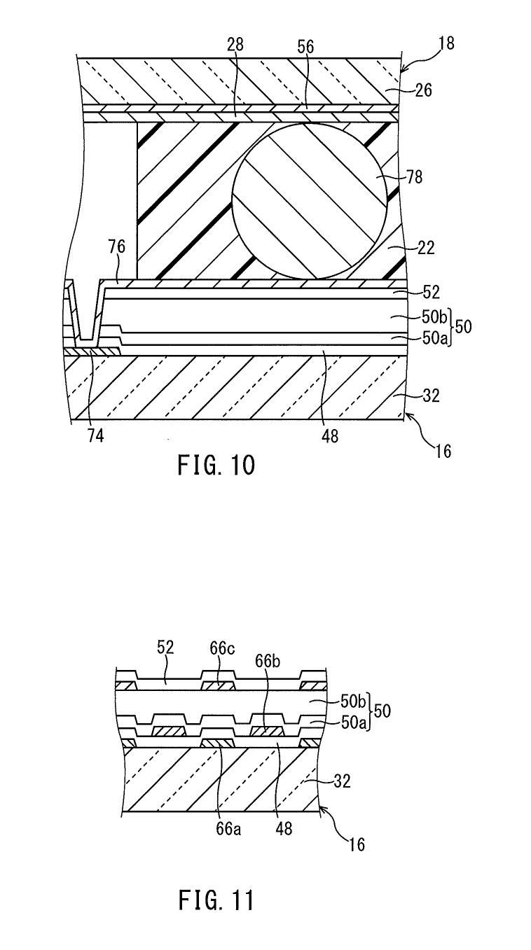

A common electrode line 74 electrically connects the drive circuit 24 with common electrodes 28. FIG. 10 shows an exemplary arrangement for electrically connecting a common electrode line 74 with a common electrode 28. In the implementation shown in FIG. 10, the common electrode line 74 is connected with a pad 76 near the seal member 22.

The pad 76 is provided in the same layer as the pixel electrodes 40. The pad 76 is in contact with the seal member 22. The seal member 22 is in contact with the common electrode 28. The seal member 22 contains conductive particles 78. The conductive particles 78 may be, for example, resin particles coated with gold. The conductive particles 78 may serve as a spacer.

As the seal member 22 contains the conductive particles 78, it is conductive. As a result, the common electrode line 74 is electrically connected with the common electrode 28 via the pad 76 and seal member 22.

A common electrode line 74 has a terminal 79. Although not shown, the terminal 79 has the same structure as the terminals 58a.

The common electrode lines 74 are connected with the drive circuit 24 mounted on the array substrate 16. The common electrode lines 74 convey voltage signals from the drive circuit 24. A voltage signal is a voltage to be applied to a common electrode 28 and, in the present embodiment, storage capacitance lines 70 are connected with a common electrode line 74. When a thin-film transistor 38 is on, a display signal is fed into the associated pixel electrode 40 via the thin-film transistor 38. At this moment, a charge that is dependent on the display signal is accumulated not only in the liquid crystal capacitor 42, but also in the storage capacitor 72. As a result, the potential of the pixel electrode 40 is stable when the thin-film transistor 38 is off even if a small amount of charge of the pixel electrode 40 is leaking via the thin-film transistor 38, for example.

In this display device, the gate lead lines 44a to 44c are distributed among a plurality of line layers. For example, as shown in FIG. 3, in the first and second regions 54a and 54b, the extended portion 46a of a first gate lead line 44a may overlap the extended portion 46c of a third gate lead line 44c as viewed from the front side of the liquid crystal panel 12. Thus, an increased number of gate lead lines 44a to 44c may be arranged in the surrounding region of the display region 14 in various ways.

Gate lead lines 44a to 44c are disposed not only in the first region 54a, but also in the second and third regions 54b and 54c. Thus, an increased number of gate lead lines 44a to 44c may be arranged in the surrounding region of the display region 14 in various ways.

First gate lead lines 44a and third gate lead lines 44c are present in the second region 54b. As viewed from the front side of the liquid crystal panel 12, a first gate lead line 44a overlaps a third gate lead line 44c without a displacement in a width direction of the parallel portion 22a. The gate insulating film 48 and first passivation film 50 are present between the first gate lead line 44a and third gate lead line 44c. This increases the distance between the first gate lead line 44a and third gate lead line 44c. This in turn reduces parasitic capacitance produced between the first gate lead line 44a and third gate lead line 44c. This reduces delay in signal transfer.

The counter substrate 18 has a light-shielding layer 56 that is present in the second region 54b as viewed from the front side of the liquid crystal panel 12. First gate lead lines 44a and third gate lead lines 44c are present in the second region 54b. As viewed from the front side of the liquid crystal panel 12, a first gate lead line 44a overlaps a third gate lead line 44c without a displacement in a width direction of the parallel portion 22a. As viewed from the front side of the liquid crystal panel 12, a gap D is formed between two adjacent extended portions arranged in a width direction of the parallel portion 22a. Thus, in implementations where the seal member 22 is a photocurable (for example, ultraviolet curing) resin, a light-permeable region is provided that is necessary to cure the seal member 22 as light is directed through the array substrate 16, even if first and third gate lead lines 44a and 44c are present in the second region 54b. This light-permeable region has different required widths depending on the width of gate lead lines. In the present embodiment, the light-permeable region has a width of 1.25 μm for gate lead lines with a width of 3 μm.

In the third region 54c, no liquid crystal 20 or seal member 22 is present between the array substrate 16 and counter substrate 18 such that the surface of the array substrate 16 is exposed to the ambient air; first and second gate lead lines 44a and 44b are present in the third region 54c; still, the second gate lead lines 44b, which are closest of these gate lines to the counter substrate 18, are covered with the passivation films 50 and 52, thereby preventing the second gate lead lines 44b from corroding.

The source lines 36 are covered with the inorganic insulating film 50a. This prevents the organic insulating film from contacting the channels of the thin-film transistors 38, which would deteriorate the properties of the thin-film transistors 38.

The terminals 58a to 58c of the first to third gate lead lines 44a to 44c have the same structure. Thus, the terminals 58a to 58c are connected with the drive circuit 24 via conductive particles generally under the same conditions. Further, during the step of checking the connection between the terminals 58a to 58c with the drive circuit 24 by observing it through the array substrate 16, pressed marks of conductive particles for the terminals 58a to 58c may be checked using the same criteria,

### Applications 1 to 6 of Embodiment

Applications 1 to 6 are different from the above embodiment in the source lead lines. In Application 1, as shown in FIG. 11, the source lead lines are first to third source lead lines 66a to 66c. The third source lead lines 66c are provided in the same line layer as the third gate lead lines 44c.

In Application 1, as viewed from the front side of the liquid crystal panel 12, a portion of a first source lead line 66a that overlaps the section 68 of the seal member 22 overlaps such a portion of a third source lead line 66c. As viewed from the front side of the liquid crystal panel 12, a gap is formed between a portion of a first source lead line 66a (or a third source lead line 66c) that overlaps the section 68 of the seal member 22 and such a portion of a second source lead line 66b.

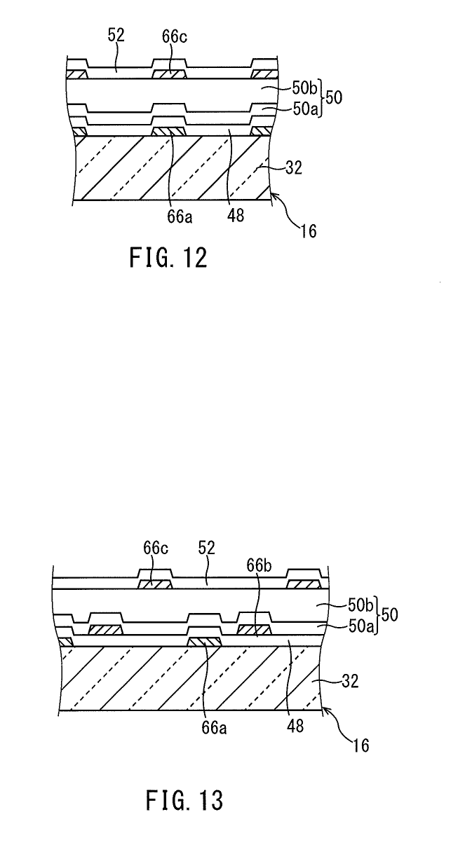

In Application 2, as shown in FIG. 12, the source lead lines are first and third source lead lines 66a and 66c. The first and third source lead lines 66a and 66c have the same width. As viewed from the front side of the liquid crystal panel 12, a first source lead line 66a overlaps a third source lead line 66c without a displacement in a width direction thereof. In Application 2, a gate insulating film 48 and first passivation film 50 are present between the first and third source lead lines 66a and 66c. This will reduce parasitic capacitance produced between a first source lead line 66a and a third source lead line 66c. This will reduce delay in signal transfer.

In Application 3, as shown in FIG. 13, the source lead lines in the same line layer are separated with a larger distance than in the above embodiment. This will prevent a leakage between two adjacent source lead lines in the same line layer.

Moreover, as shown in FIG. 13, in Application 3, a gap is formed between a first source lead line 66a and second source lead line 66b that are adjacent to each other as viewed from the front side of the liquid crystal panel 12, between a second source lead line 66b and third source lead line 66c that are adjacent to each other as viewed from the front side of the liquid crystal panel 12, and between a third source lead line 66c and first source lead line 66a that are adjacent to each other as viewed from the front side of the liquid crystal panel 12. Thus, in implementations where the seal member 22 is a photocurable resin, a light-permeable region is provided that is necessary to cure the seal member 22 as light is directed through the array substrate 16, even if first to third source lead lines 66a to 66c are present.

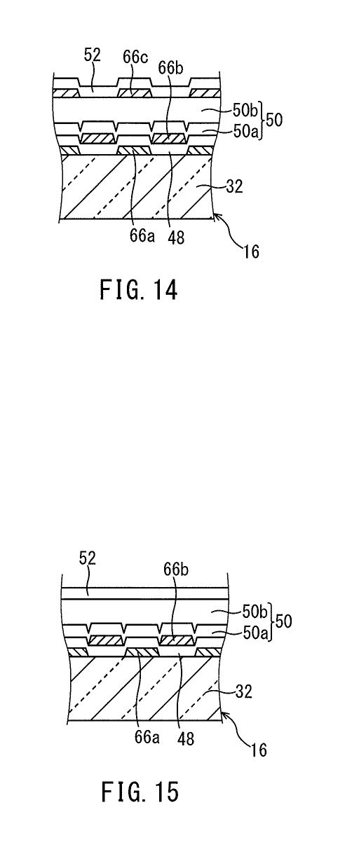

In Application 4, as shown in FIG. 14, a first source lead line 66a overlaps a third source lead line 66c as viewed from the front side of the liquid crystal panel 12. As viewed from the front side of the liquid crystal panel 12, no gap is formed between a first source lead line 66a and a second source lead line 66b, and between a second source lead line 66b and a third source lead line 66c. This does not mean that no gap at all is formed between such source lead lines, but a small gap may be formed. In the implementation shown in FIG. 14, a larger number of source lead lines 66a to 66c are provided. This will allow for image display in a higher resolution.

In Application 5, as shown in FIG. 15, the source lead lines are first and second source lead lines 66a and 66b.

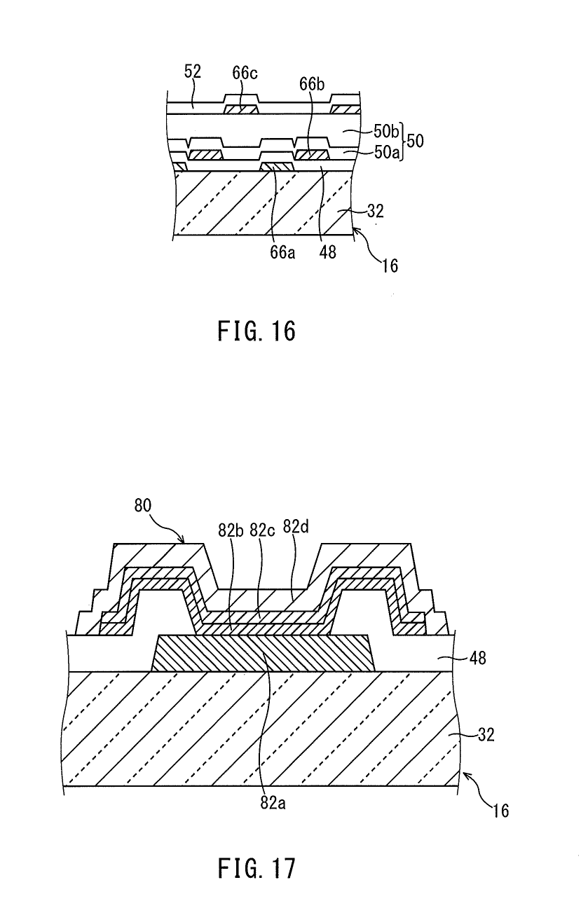

In FIG. 6, as shown in FIG. 16, the source lead lines in the same line layer are separated with a larger distance than in the above embodiment. This will prevent a leakage between two adjacent source lead lines in the same line layer.

### Application 7 of Embodiment

As shown in FIG. 17, the present application is different from the above embodiment in the structure of the terminals 80. In the embodiment, each of the terminals 58a to 58c includes first and second electrode films 60a and 60b deposited on each other, while in the present application, a terminal 80 includes first to fourth electrode films 82a to 82d deposited on each other. The first electrode film 82a is provided in the same line layer as the gate lines 34 and first gate lead lines 44a. The second electrode film 82b is provided in the same line layer as the source lines 36 and second gate lead lines 44b. The third electrode film 82c is provided in the same line layer as the third gate lead lines 44c. The fourth electrode film 82d is provided in the same layer as the pixel electrodes 40. A pad allows for connection switching, which is necessary if the electrode film of the terminals are located in a layer different from that for the gate lead lines. This will reduce the area required for connection switching.

### Application 8

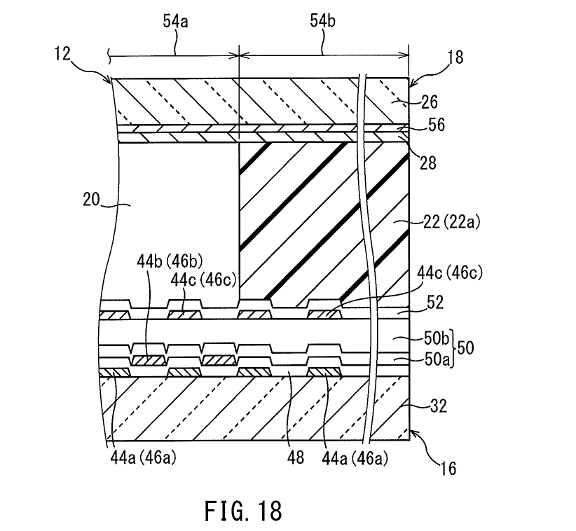

In the present application, as shown in FIG. 18, no third region 54c is provided. That is, as viewed from the front side of the liquid crystal panel 12, the seal member 22 reaches the edges of the array substrate 16. In this arrangement, even if some third gate lead lines 44c are located near the edges of the array substrate 16, those third gate lead lines 44c are not likely to corrode.

### Applications 9 to 11 of Embodiment

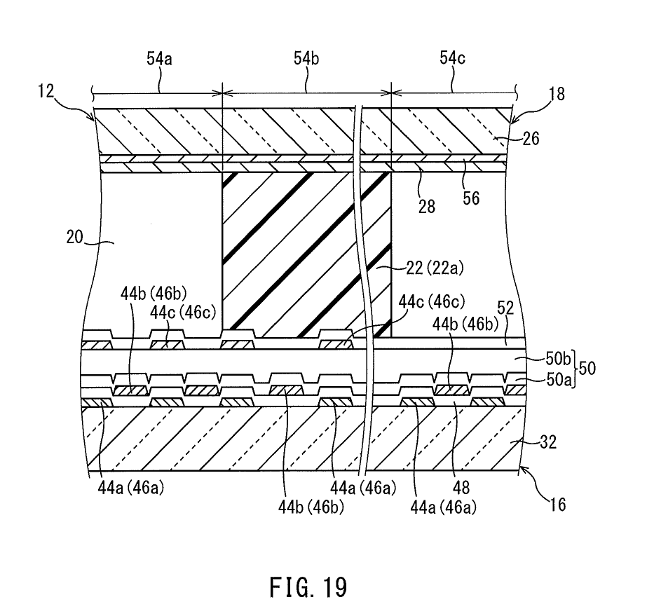

Applications 9 to 11 are different from the above embodiment in how gate lead lines are arranged in the second region 54b. In application 9, as shown in FIG. 19, the extended portions 46a to 46c of first to third gate lead lines 44a to 44c are provided in the second region 54b. This means that the number of gate lead lines present in the second region 54b is increased. This will allow for image display in a higher resolution.

Further, in Application 9, a gap is formed between the extended portion 46a of a first gate lead line 44a (or the extended portion 46c of a third gate lead line 44c) and the extended portion 46b of a second gate lead line 44b as viewed from the front side of the liquid crystal panel 12. Thus, in implementations where the seal member 22 is a photocurable resin, a light-permeable region is provided that is necessary to cure the seal member 22 as light is directed through the array substrate 16, even if the extended portions 46a to 46c of first to third gate lead lines 44a and 44c are present.

Moreover, in Application 9, the extended portions of two gate lead lines that are adjacent to each other in an identical line layer and that are located in the second region 54b are separated with a larger distance than the extended portions of two gate lead lines that are adjacent to each other in an identical line layer and that are located in the first or third region 54a or 54c. This will prevent a leakage between the extended portions of two gate lead lines that are adjacent to each other in an identical line layer and that are located in the second region 54b.

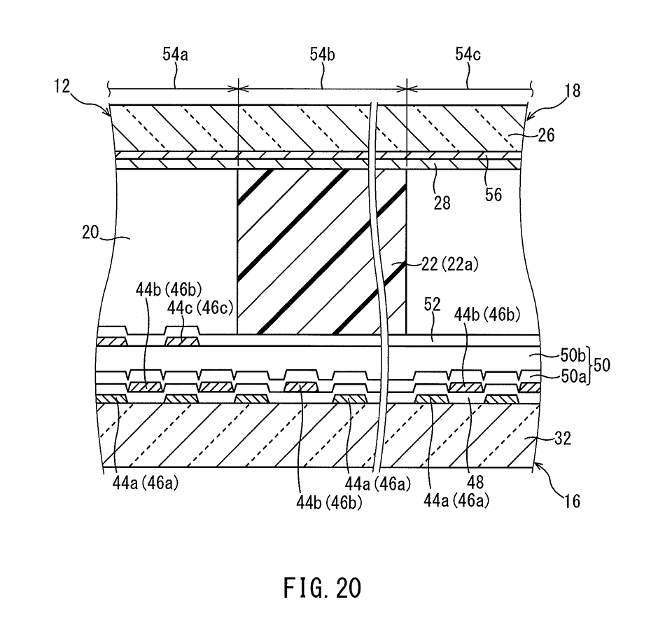

In Application 10, as shown in FIG. 20, no extended portion 46c of a third gate lead line 44c is provided in the second region 54b; instead, the extended portions 46b of second gate lead lines 44b are provided. As viewed from the front side of the liquid crystal panel 12, a gap is formed between the extended portion 46a of a first gate lead line 44a and the extended portion 46b of a second gate lead line 44b. Thus, in implementations where the seal member 22 is a photocurable resin, a light-permeable region is provided that is necessary to cure the seal member 22 as light is directed through the array substrate 16, even if the first and second gate lead lines 44a and 44b are present.

Further, in Application 10, no extended portion 46c of a third gate lead line 44c is provided in the second region 54b. This will prevent the extended portion of a gate lead line present in the second region 54b (particularly, the extended portion 46c of a third gate lead line 44c) from being broken by an external force generated as the array substrate 16 is attached to the counter substrate 18. For example, if the seal member 22 includes spacers, the extended portion of a gate lead line present in the second region 54b (particularly, the extended portion 46c of a third gate lead line 44c) may be prevented from being broken by these spacers. Furthermore, for example, if the seal member 22 contains conductive particles, the extended portions of gate lead lines present in the second region 54b (particularly, the extended portions 46c of third gate lead lines 44c) may be prevented from electrically communicating with each other via these conductive particles.

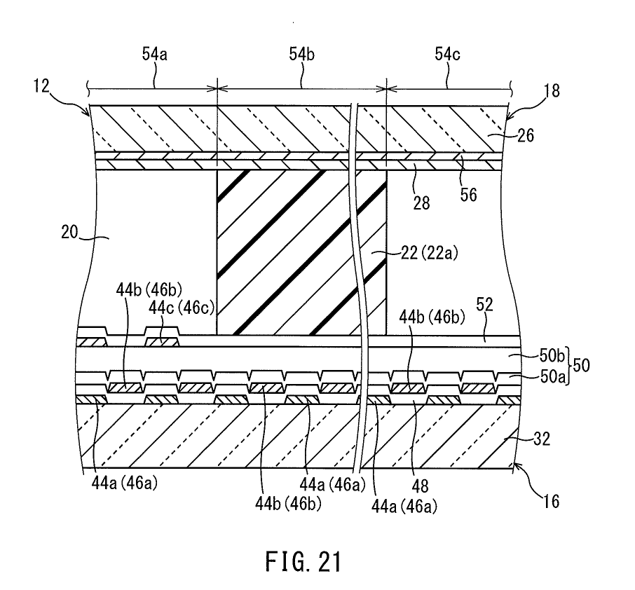

In Application 11, as shown in FIG. 21, no extended portion 46c of a third gate lead line 44c is provided in the second region 54b; instead, the extended portions 46b of second gate lead lines 44b are provided. As viewed from the front side of the liquid crystal panel 12, no gap is formed between the extended portion 46a of a first gate lead line 44a and the extended portion 46b of a second gate lead line 44b. This does not mean that no gap at all is formed between such extended portions, but a small gap may be formed. This arrangement may be provided if the seal member 22 is a thermosetting resin, thereby preventing the surrounding region of the display region 14 from being increased.

### Application 12 of Embodiment

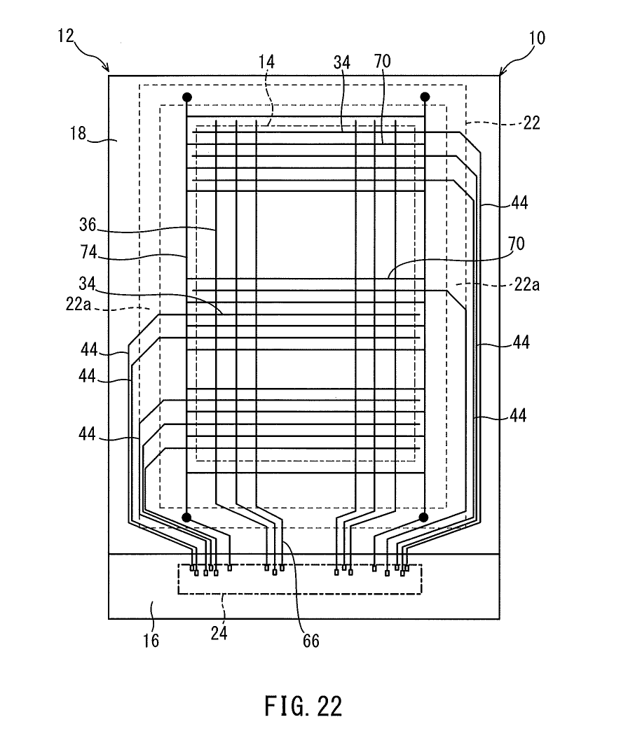

As shown in FIG. 22, this application is different from the above embodiment in how the drive circuit 24 is connected with the gate lead lines 44. In the above embodiment, the left and right gate lead lines 44 reciprocate as it goes across the display region 14 from top to bottom; in this application, gate lead lines 44 are provided to the right of the display region 14 in the upper half of the display region 14, while gate lead lines 44 are provided to the left of the display region 14 in the lower half of the display region 14.

### Application 13 of Embodiment

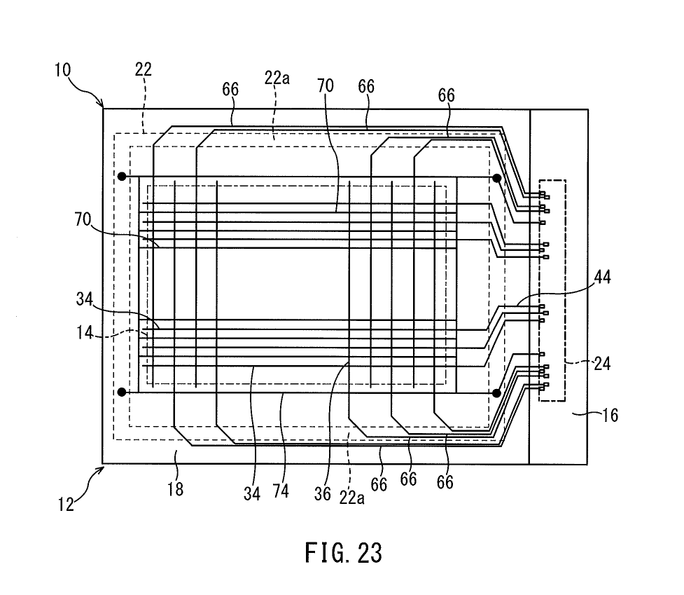

In this application, as shown in FIG. 23, upper and lower source lead lines 66 connected with the source lines 36 of the display region 14 reciprocate relative to the display region 14. As viewed from the front side of the liquid crystal panel 12, the source lead lines 66 overlap the parallel portions 22a of the seal member 22.

### Application 14 of Embodiment

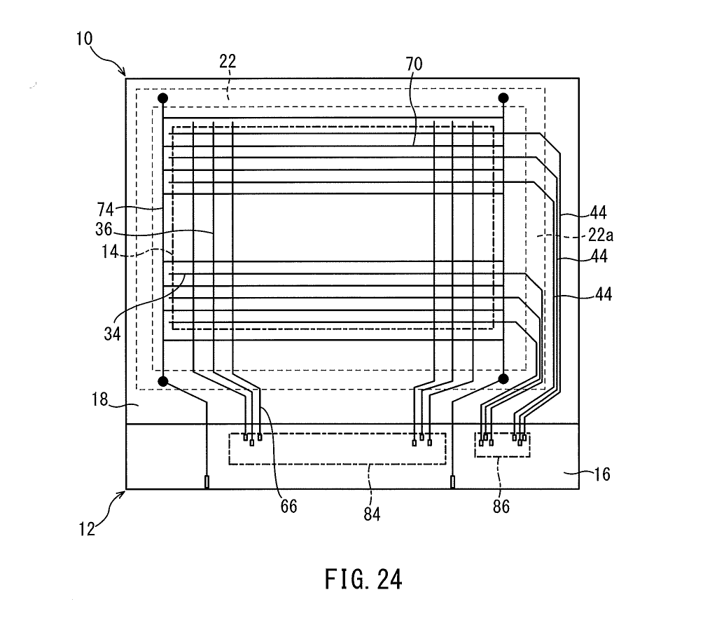

In this application, as shown in FIG. 24, the drive circuit 24 is replaced by a source driver 84 and a gate driver 86. The source driver 84 and gate driver 86 are provided along one side of the array substrate 16 (one side extending horizontally in FIG. 24). The source lead lines 66 are connected with the source driver 84. The gate lead lines 44 are connected with the gate driver 86. All the gate lead lines 44 are provided to the right portion of the liquid crystal panel 12. The common electrode lines 74 are connected with an external device (for example, a drive circuit) via an FPC, not shown. In other words, in this application, voltages to be applied to the common electrodes 28 are supplied from outside the liquid crystal panel 12.

While the embodiment of the present invention has been described in detail, this embodiment is merely an example and the present invention is not limited to the above embodiment.

For example, the above embodiment describes implementations where the display material is liquid crystal; however, the display material is not limited to liquid crystal. The display material may be, for example, an electroluminescent (EL) material, or microcapsules, some containing positively charged white particles and others with negatively charged black particles, that are mixed into a transparent insulating dispersion medium.

In the above embodiment, when the gate insulating film 48 and passivation films 50 and 52 are successively etched, the semiconductor film 62 remains on the gate insulating film 48 to serve as an etching barrier layer, which protects the portions of the gate insulating film 48 that must not be etched; however, this semiconductor film 62 need not remain on the gate insulating film 48. Of course, the passivation films 50 and 52 may be etched without a semiconductor film 62 having been formed. In such implementations, the gate insulating film 48 is etched in a step different from the etching of the passivation films 50 and 52.

In the above embodiment, first and second gate lead lines 44a and 44b are present in the third region 54c; alternatively, only first gate lead lines 44a may be present in the third region 54c, for example.

In the above embodiment, first and third gate lead lines 44a and 44c are present in the second region 54b; alternatively, only first gate lead lines 44a may be present in the second region 54b, for example.

In the above embodiment, the gate lead lines 44a to 44c have the same width; alternatively, they may have different widths. Further, in implementations where gate lead lines in different line layers overlap each other, they may be displaced relative to each other in a width direction of the parallel portion 22a.

1. A display device, comprising:
a rectangular array substrate;
a counter substrate spaced apart from the array substrate;
display material disposed between the array substrate and the counter substrate;
a seal member sealing in the display material between the array substrate and the counter substrate; and
a group of lead lines including lead lines connected with signal lines formed on the array substrate,
wherein the seal member includes a parallel portion extending parallel to one side of the array substrate,
each of the lead lines includes an extended portion extending generally in the same direction as the parallel portion,
the lead lines included in the group of lead lines are provided separately in at least three line layers deposited on the array substrate, and
the extended portion overlaps the parallel portion as viewed in a direction normal to the array substrate.

2. The display device according to claim 1, wherein the extended portions in at least two of the line layers overlap the parallel portion as viewed in a direction normal to the array substrate.

3. The display device according to claim 2, wherein the at least two of the line layers include:
a first line layer located closest to a base substrate of the array substrate; and
a second line layer located adjacent a side of the first line layer opposite that facing the base substrate and located closest to the first line layer, and
an insulating layer provided between the second line layer and the parallel portion has a thickness larger than that of an insulating film provided between the first line layer and the second line layer.

4. The display device according to claim 3, wherein the parallel portion includes a spacer that defines a distance between the array substrate and the counter substrate.

5. The display device according to claim 3, wherein the parallel portion contains conductive particles.

6. The display device according to claim 3, wherein the insulating layer includes an organic insulating film.

7. The display device according to claim 2, wherein the at least two of the line layers include:
a first line layer located closest to a base substrate of the array substrate; and
a third line layer located closest to the seal member.

8. The display device according to claim 2, wherein:
the counter substrate includes a light-shielding layer overlapping the parallel portion as viewed in a direction normal to the counter substrate,
a gap is formed between two of the extended portions overlapping the parallel portion as viewed in a direction normal to the array substrate, the two extended portions being adjacent to each other as measured in a width direction of the parallel portion, and
the seal member is a photocurable resin.

9. The display device according to claim 1, wherein the seal member is a thermosetting resin.

10. The display device according to claim 1, wherein the extended portion is located inward of the seal member as viewed in a direction normal to the array substrate.

11. The display device according to claim 1, wherein the extended portion is located outward of the seal member as viewed in a direction normal to the array substrate.

12. The display device according to claim 11, wherein the extended portion located outward of the seal member as viewed in a direction normal to the array substrate is provided in a line layer located closer to a base substrate of the array substrate than one of the at least three line layers deposited on the array substrate which is located closest to the seal member.

13. The display device according to claim 1, wherein each of the lead lines included in the group of lead lines has a terminal connected with a drive circuit mounted on the array substrate, and the terminals have the same structure.

14. The display device according to claim 13, wherein each terminal includes a plurality of conductive layers deposited on each other.
